(19) United States
(12) Patent Application Publication
(10) Pub. No.: US 2017/0201707 A1
(43) Pub. Date: Jul. 13, 2017

(54) TELEVISION MANAGING APPARATUS AND TELEVISION MANAGING METHOD COOPERATING WITH REMOTE CONTROLLER

(71) Applicant: MStar Semiconductor, Inc., Hsinchu Hsien (TW)

(72) Inventors: Yi-Shin Tung, Zhubei City (TW); He-Yuan Lin, Zhubei City (TW); Hung-Wei Yang, Zhubei City (TW)

(21) Appl. No.: 15/403,333

(22) Filed: Jan. 11, 2017

(30) Foreign Application Priority Data
Jan. 12, 2016 (TW) 105100820

(51) Int. Cl. H04N 5/44; H04N 21/422

(52) U.S. Cl. CPC H04N 5/4403; H04N 21/42204; H04N 2005/4444; H04N 2005/4428

(57) ABSTRACT

A television managing apparatus cooperating with a remote controller includes a receiver and a controller. The receiver receives an instruction sent from the remote controller. The controller actives a performance optimization process in response to each latest instruction that the receiver receives.

This application claims the benefit of Taiwan application Serial No. 105100820, filed Jan. 12, 2016, the subject matter of which is incorporated herein by reference.

### BACKGROUND OF THE INVENTION

Field of the Invention

The invention relates in general to a television system, and more particularly, to an interaction mechanism between a remote controller and a television system.

Description of the Related Art

Television systems are essential equipments in most households. With the continual processing of electronics-related technologies, many commercial television systems in the recent years are capable of playing audiovisual data and providing numerous functions originally primarily offered by computer systems. More specifically, in addition to playing audiovisual data, such types of so-called smart televisions are also capable of executing a complete operating system and many applications as well as connecting to the Internet to transceive information.

The dynamic voltage and frequency scaling (DVBS) technology extensively applied in computer systems increases the upper limit of an operating frequency (commonly referred to as overclocking) of a circuit through increasing a supply voltage, or reduces the power consumption for operating a circuit through lowering a supply voltage. In current technologies, the DVFS technology is also promoted to smart televisions having similar system architectures. A smart television system decides whether to adjust its supply voltage/operating frequency according to a utilization level of a core processor (e.g., whether a utilization rate is higher than a predetermined threshold). However, such approach suffers from a drawback of providing a user with insufficient operation smoothness. For example, assume that a user transmits an instruction of activating an application to a smart television through a remote controller. One possible scenario is that, software/hardware resources of the smart television have already been allocated to many other active applications, the task of activating a new application is scheduled into a task queue, and an up-conversion procedure is only triggered when the utilization rate of a core processor of the smart television exceeds the threshold after a certain period of time. In practice, starting to activate to completing the up-conversion procedure requires a short conversion period before the up-conversion procedure substantially contributes to the working efficiency of the processor. Thus, it is known that, in the above scenario, even if the up-conversion procedure of the core processor is activated in response to activating a new application by the user, a noticeable amount of time is still required from the moment that the user presses the remote controller to a point that the smart television really completes activating the corresponding application. From the aspect of the user, a smart television that cannot immediately respond to an instruction from a remote controller is unsatisfactory, and the improvement that current technologies provide upon user perception is rather limited.

### SUMMARY OF THE INVENTION

The invention is directed to a television managing apparatus and a television managing method cooperating with a remote controller.

According to an embodiment of the present invention, a television managing apparatus cooperating with a remote controller is provided. The television managing apparatus includes a receiver and a controller. The receiver receives an instruction sent from the remote controller. The controller activates a performance optimization process in response to each latest instruction that the receiver receives.

According to an embodiment of the present invention, a television managing method cooperating with a remote controller is provided. An instruction sent from the remote controller is received, and a performance optimization process is activated in response to each latest instruction received.

According to an embodiment of the present invention, a television managing apparatus cooperating with a remote controller is provided. The television managing apparatus includes a receiver and a controller. The control circuit includes a prediction circuit and a performance optimization activating circuit. The receiver receives an instruction sent from the remote controller. Before the receiver completely receives a latest instruction, the prediction circuit predicts the latest instruction according to a partial instruction associated with the latest instruction that the receiver receives to generate a prediction result. The performance optimization activating circuit activates a performance optimization process in response to the prediction result.

According to an embodiment of the present invention, a television managing method cooperating with a remote controller is provided. An instruction sent from the remote controller is received. Before a latest instruction is completely received, the latest instruction is predicted according to a partial instruction associated with the latest instruction to generate a prediction result. A performance optimization process is activated in response to the prediction result.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a function block diagram of a television managing apparatus and a smart television cooperating with the television managing apparatus according to an embodiment of the present invention;

FIG. 2(A) to FIG. 2(C) are several detailed implementation examples of a controller in a television managing apparatus of the present invention;

FIG. 3 is a flowchart of a television managing method according to an embodiment of the present invention;

FIG. 4 is a function block diagram of a television managing apparatus and a smart television cooperating with the television managing apparatus according to another embodiment of the present invention; and

FIG. 5 is a flowchart of a television managing method according to another embodiment of the present invention.

It should be noted that, the drawings of the present invention include functional block diagrams of multiple functional modules related to one another. These drawings are not detailed circuit diagrams, and connection lines therein are for indicating signal flows only. The interactions between the functional elements/or processes are not necessarily achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

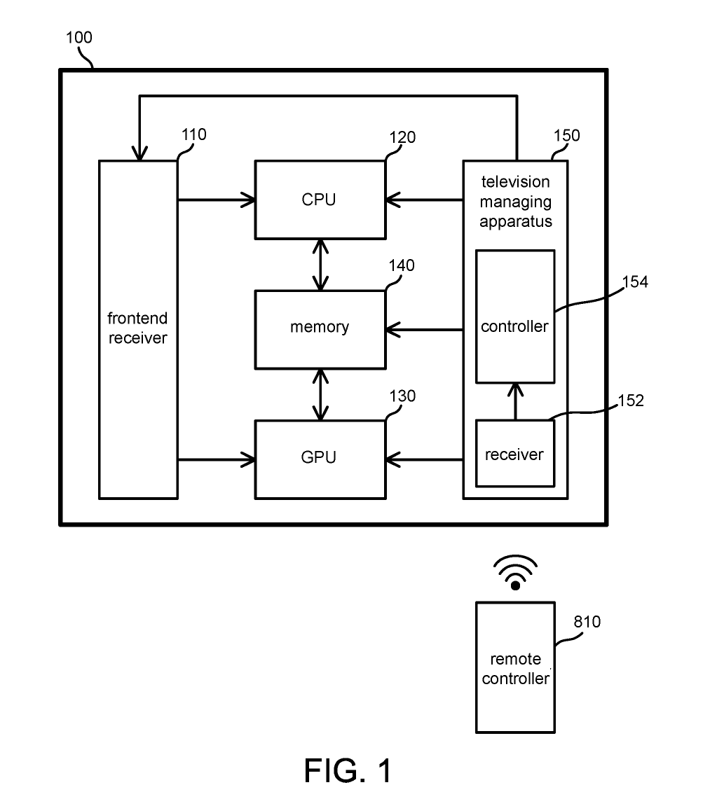

A television managing apparatus and a television managing method of the present invention may cooperate with various types of smart televisions that are controllable by a remote controller, and may be integrated into a smart television or a control chip of a peripheral device (e.g., a set-up box (STB)) of the smart television. FIG. 1 shows a functional block diagram of a television managing apparatus, which may be integrated in a smart television, according to an embodiment of the present invention. In this embodiment, a smart television 100 cooperating with a remote controller 810 includes a frontend receiver 110, a central processing unit (CPU) 120, a graphics processing unit (GPU) 130, a memory 140, and a television managing apparatus 150. To keep the drawing simple, audiovisual playback devices, such as a monitor and a sound amplifying element, are not depicted. It should be noted that, the scope of the present invention is not limited to implementing the smart television 100 by a particular configuration or structure. With the following description, one person skilled in the art may understand that there are many other circuit configurations and elements capable of realizing the concept of the present invention without departing from the spirit of the present invention.

The frontend receiver 110 receives a television signal from the external of the smart television 100. In practice, the frontend receiver 110 may include one or multiple tuners, which respectively receive a digital cable television signal, a digital wireless television signal, an analog cable television signal or an analog wireless television signal. The frontend receiver 110 may further include a demodulating circuit, a decoding circuit of an image processing circuit that perform demodulating, decoding and image adjusting processes on audiovisual data retrieved from the external television signal. An output signal of the frontend receiver 110 may be selectively forwarded to the CPU 120 and/or the GPU 130.

The CPU 120 is primarily in charge of operating an operating system and various applications in the smart television 100. The GPU 130 is in charge of processing image related operations and sharing a work load of the CPU 120. The scope of the present invention is not limited to a particular storage mechanism. The memory 140 may include one or multiple volatile or non-volatile memory devices, e.g., random access memory (RAM), read-only memory (ROM), magnetic and/or optical memory, and flash memory devices. In practice, the memory 140 may include a main memory and a cache. The main memory stores long-term data and program codes; the cache temporarily stores a small amount of data that is recently used or soon to be used by the CPU 120 and the GPU 130.

As shown in FIG. 1, the television managing apparatus 150 includes a receiver 152 and a controller 154. The receiver 152 receives an instruction sent from the remote controller 810. In practice, the instruction sent from the remote controller 180 to the receiver 152 may be transmitted through radio-frequency (RF) signals, infrared signals or wireless signals. In other words, for example but not limited to, the receiver 152 may be an RF signal receiver or an infrared signal receiver. In practice, the instruction sent from the remote controller 810 may include, for example, various kinds of user instructions such activating/shutting down an applications, adjusting volume, adjusting image brightness/contrast, switching television program channels, and inputting user-defined data. When the remote controller 810 is provided with a motion sensing element such as an accelerator or a gyroscope, a sensing result of the sensing element may serve as a command motion message that is transmitted in form of an instruction to the receiver 152.

The controller 154 activates a performance optimization process in response to each latest instruction that the receiver 152 receives. In one embodiment, each time the receiver 152 receives a latest instruction from the remote controller 810, the controller 154 activates a CPU frequency adjusting process (e.g., increasing a supply voltage) to raise the operating frequency of the CPU 120. Most tasks in the CPU 120 and the smart television 100 are related. In general, increasing the operating frequency of the CPU 120 effectively shortens the time needed for the smart television 100 to respond to and to achieve the latest instruction; for example, an application may be more promptly activated or a television channel may be more quickly switched. In one embodiment, only when one latest instruction from the remote controller 810 is received after a predetermined period within which no instruction is received, the controller 154 then activates the CPU frequency adjusting process to satisfy requirements of both promptly activating an application and power saving.

In another embodiment, in response to different types of instructions, the controller 154 adaptively activates different performance optimization processes. For example, when the latest instruction that the receiver 152 receives involves operation resources of the GPU 130, the controller 154 may correspondingly activate a GPU frequency adjusting process to increase the operating frequency of the CPU 130, hence allowing the latest instruction to be more promptly achieved. On the other hand, when the latest instruction that the receiver 152 receives requires the memory 140, the control circuit 154 may activate a memory access priority adjusting process to allow a task associated with this latest instruction to obtain a higher or even a highest memory access priority. For another example, when the latest instruction that the receiver 152 receives requires the cache in the memory 140, the controller 154 may activate a cache memory clearing process to clear less important or older data from the cache, so as to provide the latest instruction with more cache space. These optimization processes help reducing the time that the smart television 100 needs to respond to and achieve the latest instruction. It should be noted that, for one latest instruction, the controller 154 may simultaneously activate more than one performance optimization process.

In one embodiment, the remote controller 810 detects a motion that the user applies on the remote controller 810, and transmits a detection result to the receiver 152, to indicate that the remote controller 810 is moved or touched by the user or a key on the remote controller 810 is pressed by the user. The controller 154 may also activate a performance optimization process in response to such type of command motion messages. For example, each time the receiver 152 receives a command motion message that indicates the user moves or touches the remote controller 810 or presses a key on the remote controller 810, the controller 154 may activate an application preloading process to cause the CPU 120 to preload one or multiple applications recently shut down to the cache in the memory 140. In the event that a next motion of the user is activating one of the preloaded applications through the remote controller 810, the smart television 100 is capable of more promptly completing the task.

As opposed to the prior art, with the above performance optimization processes, the smart television 100 apparently responds to the user within a shorter time after an instruction is sent through the remote controller 810. Thus, the operation smoothness of the user is enhanced to achieve the better user satisfaction.

It should be noted that, implementation details of optimization technologies for adjusting the CPU frequency, adjusting the memory access priority and preloading applications are generally known to one person skilled in the art, and shall be omitted herein.

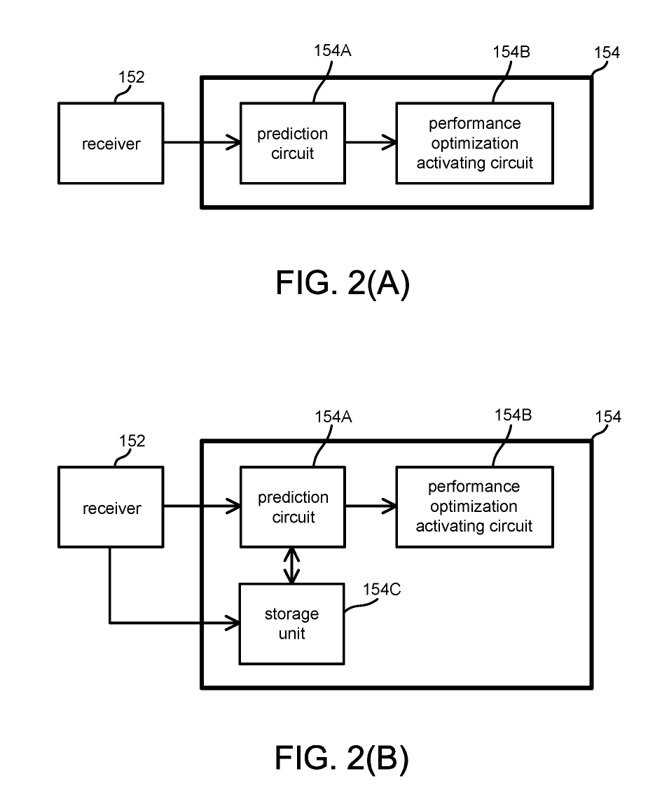

In practice, the controller 154 may be realized using various kinds of control and processing platforms, including a fixed and programmable logic circuit, a programmable logic gate array, an application-specific integrated circuit (ASIC), a microcontroller, a microprocessor and a digital signal processor (DSP). Alternatively, the controller 154 may also be designed as a processor instruction stored in the memory 140, and the processor instruction may be executed by the CPU 120 or the GPU 130 to perform various kinds of tasks. FIG. 2(A) to FIG. 2(C) further show several detailed implementation examples of the controller 154, with associated description given below.

The controller 154 in FIG. 2(A) includes a prediction circuit 154A and a performance optimization activating circuit 154B. Before the receiver 152 completely receives a latest instruction, the prediction circuit 154A predicts the latest instruction according to a partial instruction, which is received by the receiver 152 and is associated with the latest instruction. For example, assuming that the keys on the remote controller 810 respectively correspond to different 8-bit American Standard Code for Information Interchange (ASCII) codes. After the receiver 152 receives the first 6 bits corresponding to the latest instruction, the prediction circuit 154A may infer one or multiple key possibilities (i.e., the same keys corresponding to the first 6 bits and the partial instruction) corresponding to the latest instruction, and select one as a prediction result. The performance optimization activating circuit 154B then activates a performance optimization process in response to the prediction result that the prediction circuit 154A generates. For example, if the prediction circuit 154A predicts that the latest instruction about to take place according to the partial instruction received is playing a prerecorded video file, the performance optimization process activated by the performance optimization activating circuit 154B may be preloading a part of the prerecorded video file to the cache in the memory 140.

As shown in FIG. 2(B), the controller 154 may further include a storage unit 154C, which stores an instruction archive associated with an instruction that the receiver 152 previously received for the reference of the prediction circuit 154A to generate the prediction result. For example, assume that the frontend receiver 110 includes two tuners, with one of the two tuners current set to receiving a television program that is being watched by the user. When the partial instruction received by the receiver 152 indicates that the number key 6 on the remote controller 810 is pressed, the prediction circuit 154A may infer that the latest instruction soon to arrive is switching the television channel to channel 6 or to channel 6-something. If the instruction archive in the storage unit 154 indicates that the user of the smart television 100 watches the television program of channel 65 most frequently in this timeslot, the prediction circuit 154A further accordingly selects channel 65 as the prediction result. Next, the performance optimization activating circuit 154B may activate a circuit pre-activating process, so as to control the other tuner originally being idle to enter a normal operation state and to set the frequency range for receiving signals to receiving signals of channel 65. Alternatively, the performance optimization activating circuit 154B may also raise the priority for accessing the memory 140 for a circuit (e.g., the decoder in the frontend receiver 110) associated with the channel switch task. As such, if the user indeed is sending an instruction for switching to channel 65 through the remote controller, the smart television 100 may then promptly complete channel switching and start playing the program on channel 65. It should be noted that, the technology of changing the frequency range for receiving signals of a tuner based on requirements are generally known to one person skilled in the art, and shall be omitted herein. Further, in practice, the storage unit 154C may be integrated in the memory 140.

In one embodiment, in addition to activating a performance optimization process according to the prediction result that the prediction circuit 154A generates, after the receiver 152 completes receiving a latest instruction, the performance optimization activating circuit 154B further adjusts the performance optimization process or activates another performance optimization process according to the complete latest instruction. For example, if the prediction result generated by the prediction circuit 154A according to the partial instruction is “user wishes to activate application A1” but the latest instruction received by the receiver 152 is “user wishes to activate application A2”, the performance optimization activating circuit 154B then transfers the higher memory access originally allotted to the application A1 to the application A2. For another example, assume that the performance optimization activating circuit 154B previously allotted a higher memory access priority to the associated circuit in the frontend receiver 110 in response to the prediction result of “switching to channel 65”. If the latest instruction completely received later indicates that the user indeed wishes to switch to channel 65, the performance optimization activating circuit 154B may further increase the operating frequency of the GPU 130 to assist in more promptly displaying the television image of channel 65.

In the embodiment in FIG. 2(C), the controller 154 includes the performance optimization activating circuit 154B, and a performance optimization suspending circuit 154D that determines an ending time of a performance optimization operation activated by the performance optimization activating circuit 154B. For example, the ending time may be determined according to a user-predetermined condition. Assuming that the user-predetermined condition is 5 seconds, the performance optimization process that the performance optimization activating circuit 154B activates in response for each latest instruction automatically ends after 5 seconds. In practice, the so-called user may be a circuit designer, or an actual user of the smart television 100. Alternatively, the performance optimization suspending circuit 154D may be designed to determine the ending time according to a system environment parameter. The system environment parameter may include one or multiple of the following parameters: a system load, a system temperature and a system power consumption. For example, the performance optimization suspending circuit 154D may end the performance optimization process activated in response to an instruction from a remote controller when the system temperature rises to higher than a predetermined threshold.

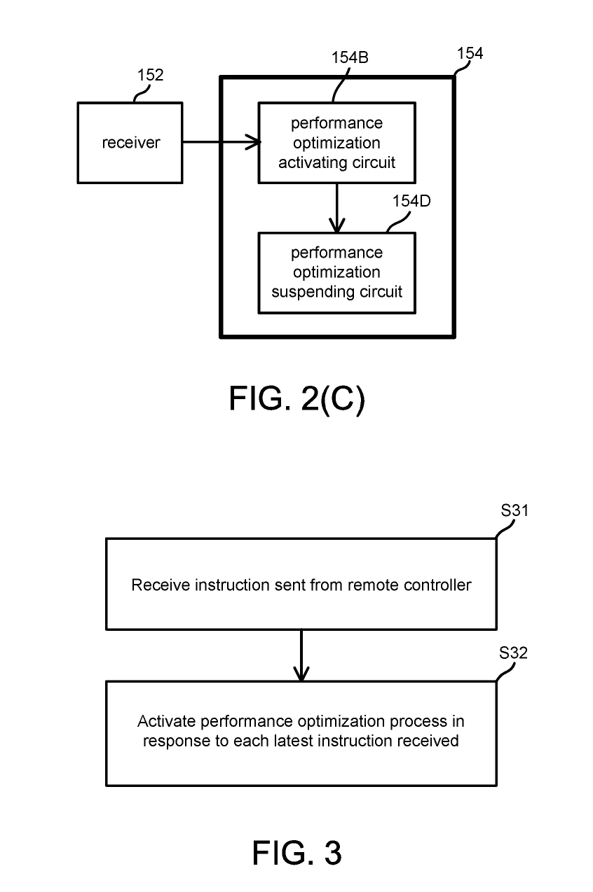

FIG. 3 shows a flowchart of a television managing method cooperating with a remote controller according to another embodiment of the present invention. In step S31, an instruction sent from the remote controller is received. In step S32, a performance optimization process is activated in response to each latest instruction received. One person skilled in the art can understand that, operation variations and modifications in the description associated with the smart television 100 and the television managing apparatus 150 are applicable to the television managing method in FIG. 3, and shall be omitted herein.

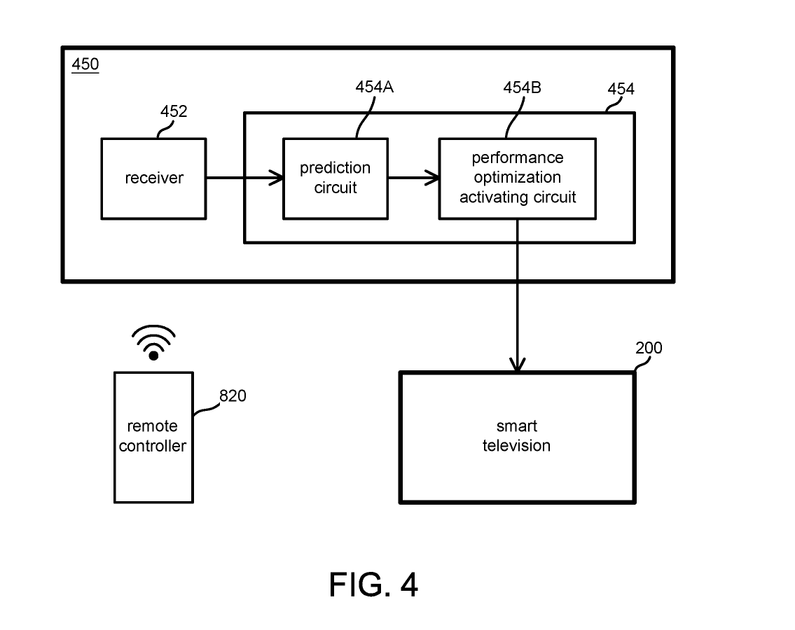

FIG. 4 shows a function block diagram of a television managing apparatus cooperating with a remote controller according to another embodiment of the present invention. A television managing apparatus 450 includes a receiver 452 and a controller 454. The controller 454 includes a prediction circuit 454A and a performance optimization activating circuit 454B. The receiver 452 receives an instruction sent from a remote controller 820. Before the receiver 452 completely receives a latest instruction, the prediction circuit 454A predicts the latest instruction according to a partial instruction, which is received by the receiver 452 and is associated with the latest instruction, to generate a prediction result. The performance optimization activating circuit 454B controls a smart television 200 to activate a performance optimization process in response to the prediction result.

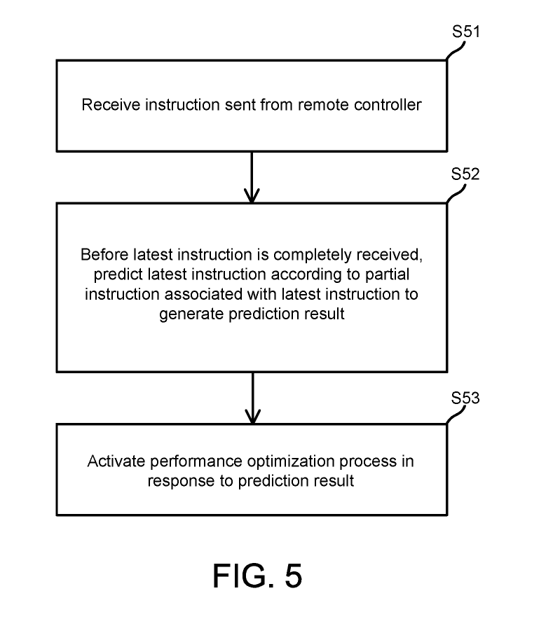

FIG. 5 shows a flowchart of a television managing method cooperating with a remote controller according to another embodiment of the present invention. In step S51, an instruction sent from the remote controller is received. In step S52, before a latest instruction is completely received, the latest instruction is predicted according to a partial instruction received and associated with the latest instruction to generate a prediction result. In step S53, a performance optimization process is activated in response to the prediction result.

It should be noted that, although the television managing apparatus 450 in FIG. 4 and the television managing method in FIG. 5 may not perform the performance optimization process for every single latest instruction received from a remote controller, operation variations and modifications (e.g., the types of performance optimization process or the determination basis for ending the performance optimization process) in the description associated with the smart television 100 and the television managing apparatus 150 are applicable to television managing apparatus 450 in FIG. 4 and the television managing method in FIG. 5, and shall be omitted herein.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A television managing apparatus cooperating with a remote controller, comprising:
a receiver, receiving an instruction sent from the remote controller; and
a controller, activating a performance optimization process according to one of the instruction and a partial instruction included in the instruction.

2. The television managing apparatus according to claim 1, wherein the performance optimization process comprises at least one of following processes: a central processing unit (CPU) frequency adjusting process, a graphics processing unit (GPU) frequency adjusting process, a memory access priority adjusting process, a cache clearing process, and an application preloading process.

3. The television managing apparatus according to claim 2, wherein when the receiver does not receive any instruction for a predetermined period before receiving the instruction, the performance optimization process comprises the CPU frequency adjusting process.

4. The television managing apparatus according to claim 1, wherein the controller comprises:
a prediction circuit, predicting the instruction according to the partial instruction to generate a prediction result before the receiver completely receives the instruction; and
a performance optimization activating circuit, activating the performance optimization process according to the prediction result.

5. The television managing apparatus according to claim 4, wherein the controller further comprises:
a storage unit, storing an instruction archive, which is associated with a plurality of instructions previously received by the receiver; and
the prediction circuit generates the prediction result according to the partial instruction and the instruction archive.

6. The television managing apparatus according to claim 4, wherein the performance optimization process comprises a circuit pre-activating process.

7. The television managing apparatus according to claim 4, wherein, after the receiver completely receives the instruction, the performance optimization activating circuit further selectively adjusts the performance optimization process and activating another performance optimization process according to the instruction.

8. The television managing apparatus according to claim 1, wherein the controller comprises:
a performance optimization suspending circuit, determining an ending time of the performance optimization process according to at least one of a user-predetermined condition and a system environment parameter.

9. The television managing apparatus according to claim 1, wherein the instruction comprises a command motion message that indicates the remote controller is moved, touched or pressed according to a predetermined method by a user.

10. A television managing method cooperating with a remote controller, comprising:
a) receiving an instruction sent from the remote controller; and
b) activating a performance optimization process according to one of the instruction and a partial instruction included in the instruction.

11. The television managing method according to claim 10, wherein the performance optimization process comprises at least one of following processes: a central processing unit (CPU) frequency adjusting process, a graphics processing unit (GPU) frequency adjusting process, a memory access priority adjusting process, a cache clearing process, and an application preloading process.

12. The television managing method according to claim 10, wherein step (b) comprises:
b1) before the instruction is completely received, predicting the instruction according to the partial instruction to generate a prediction result; and
b2) activating the performance optimization process according to the prediction result.

13. The television managing method according to claim 12, further comprising:
storing an instruction archive;
wherein, step (b1) generates the prediction result according to the partial instruction and the instruction archive.

14. The television managing method according to claim 12, wherein the performance optimization process comprises a circuit pre-activating process.

15. The television managing method according to claim 12, further comprising:
after receiving the instruction is completely received, selectively adjusting the performance optimization process and activating another performance optimization process according to the instruction.

16. The television managing method according to claim 12, further comprising:
determining an ending time of the performance optimization process according to at least one of a user-predetermined condition and a system environment parameter.

17. The television managing method according to claim 10, wherein the instruction comprises a command motion message that indicates the remote controller is moved, touched or pressed according to a predetermined method by a user.

18. A television managing apparatus cooperating with a remote controller, comprising:
a receiver, receiving an instruction sent from the remote controller; and
a controller, comprising:
a prediction circuit, predicting the instruction according to the partial instruction to generate a prediction result before the receiver completely receives the instruction; and
a performance optimization activating circuit, activating the performance optimization process according to the prediction result.

19. The television managing apparatus according to claim 18, wherein the performance optimization process at least comprises one of following processes: a central processing unit (CPU) frequency adjusting process, a graphics processing unit (GPU) frequency adjusting process, a memory access priority adjusting process, a cache clearing process, and an application preloading process.

20. The television managing apparatus according to claim 18, wherein the controller further comprises:
a storage unit, storing an instruction archive, which is associated with a plurality of instructions previously received by the receiver; and
the prediction circuit generates the prediction result according to the partial instruction and the instruction archive.
